(19) United States
(12) Patent Application Publication
(10) Pub. No.: US 2019/0306073 A1
(43) Pub. Date: Oct. 3, 2019

(54) METHOD AND DEVICE FOR ENHANCING THE THROUGHPUT BETWEEN SMART METER AND SERVER

(71) Applicant: Wistron NeWeb Corp., Hsinchu (TW)

(72) Inventors: Cheng-Jung WEN, Hsinchu (TW); Wen-Jin LEE, Hsinchu (TW)

(21) Appl. No.: 16/251,310

(22) Filed: Jan. 18, 2019

(30) Foreign Application Priority Data
Mar. 29, 2018 (TW) 107110941

(51) Int. Cl. H04L 12/891; G01D 4/00; H04L 29/12; H04Q 9/00

(52) U.S. Cl. CPC H04L 47/41; G01D 4/002; H04Q 2209/43; H04Q 9/00; H04Q 2209/60; H04L 61/2007

(57) ABSTRACT

A method for enhancing the throughput between smart meters and a server is provided. The method is used in a device and includes: establishing a temporary storage area; temporarily storing one or more data transmitted by at least one smart meter into the temporary storage area; determining whether a condition is satisfied; aggregating the data in the temporary storage area into a data frame to generate an aggregated packet including the data frame and a header frame when determining that the condition is satisfied; and transmitting the aggregated packet to the server.

### CROSS REFERENCE TO RELATED APPLICATIONS

This application claims priority from Taiwan Patent Application No. 107110941, filed on Mar. 29, 2018, the disclosure of which is incorporated herein by reference in its entirety.

### BACKGROUND

### Technical Field

The present disclosure generally relates to a method and a device for enhancing the throughput between smart meters and a server. More specifically, aspects of the present disclosure relate to a method and a device for enhancing the throughput between smart meters and a server using the concept of packet aggregation.

### Description of the Related Art

Smart meters are power meters able to collect and transmit power usage data of power used within a residence to enable the power company to read power usage remotely, and may also be used to provide the consumer with real-time or up-to-date power usage information.

Currently, a smart meter installed in a home can be connected to a hub at home via ZigBee or Bluetooth, and can transmit power data through the hub to the server of the power company. After receiving the power data, the hub converts the power data into an Internet Protocol (IP) packet and transmits the IP packet to the server through the 4G LTE network to provide the power data to the server.

The power meter transmitted by the smart meter is basically less than 64 bytes. However, in the metropolitan area, there may be tens of thousands or hundreds of thousands of users' smart meters uploading power data to the server through the hub. It may cause that the load on the server is too heavy and the throughput is low. For example, as shown in FIG. 1, the IP packet 100 converted from the power data by the hub is a minimum of 64 bytes, wherein the header frame 110 is 20 bytes, and the data frame 120 is 44 bytes. In other words, only 68.75% of the IP packet transmitted by the hub is actual power usage data. Since the ratio of the header frame 110 to the IP packet 100 is as high as 31.25%, it may result in wasting of a portion of the bandwidth.

Therefore, how to enhance the throughput between smart meters and a server is an urgent problem that needs to be solved.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

A method for enhancing the throughput between smart meters and a server is provided in the disclosure. The method is used in a device and comprises: establishing a temporary storage area; temporarily storing one or more data transmitted by at least one smart meter into the temporary storage area; determining whether a condition is satisfied; aggregating the data in the temporary storage area into a data frame to generate an aggregated packet including the data frame and a header frame when determining that the condition is satisfied; and transmitting the aggregated packet to the server.

A device for enhancing the throughput between smart meters and a server is provided in the disclosure. The device comprises one or more processors and one or more computer storage media for storing one or more computer-readable instructions. The processor is configured to drive the computer storage media to execute the following tasks: establishing a temporary storage area; temporarily storing one or more data transmitted by at least one smart meter into the temporary storage area; determining whether a condition is satisfied; aggregating the data in the temporary storage area into a data frame to generate an aggregated packet including the data frame and a header frame when determining that the condition is satisfied; and transmitting the aggregated packet to the server.

### BRIEF DESCRIPTION OF DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 shows a schematic diagram showing an IP packet.

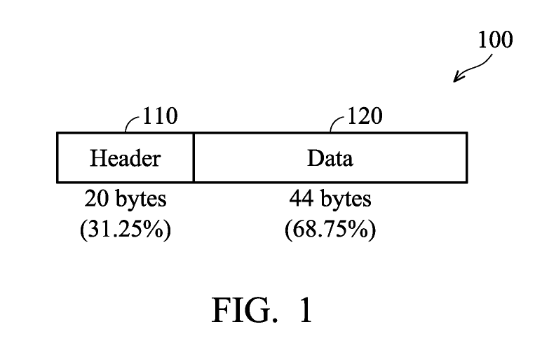

FIG. 2 shows a schematic diagram of a system for enhancing the throughput between smart meters and a server according to one embodiment of the present disclosure.

FIG. 3 is a flowchart illustrating a method for enhancing the throughput between smart meters and a server according to an embodiment of the present disclosure.

FIG. 4 is a flowchart illustrating a method for enhancing the throughput between smart meters and a server according to an embodiment of the present disclosure.

FIG. 5 is a schematic diagram showing an aggregated packet according to an embodiment of the present disclosure.

FIG. 6 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

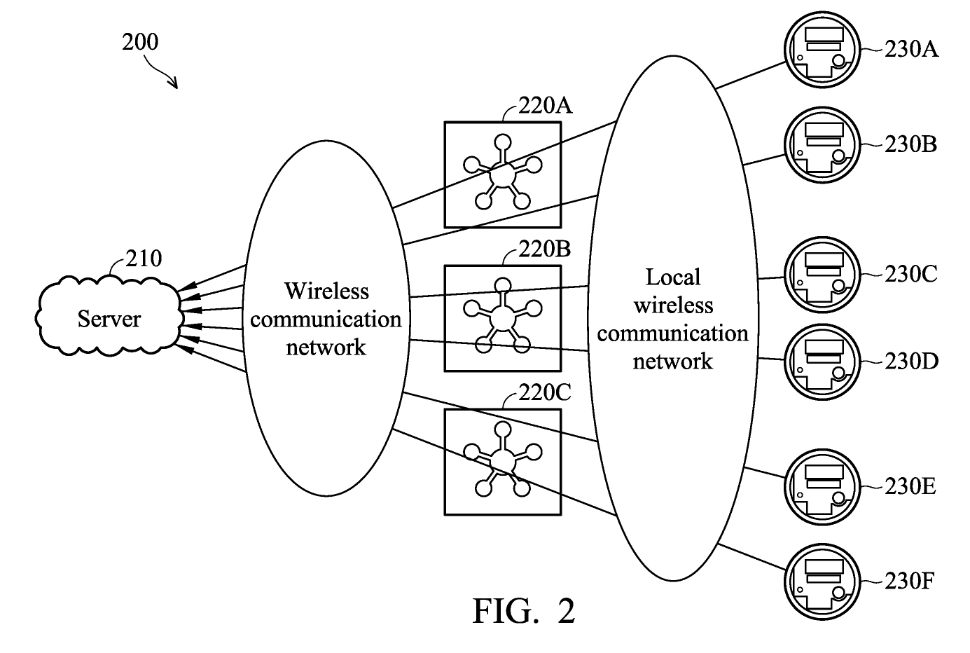

FIG. 2 shows a schematic diagram of a system 200 for enhancing the throughput between smart meters and a server according to one embodiment of the present disclosure. The system 200 may comprise a server 210, one or more electronic devices 220A-220C, and one or more smart meters 230A-230F.

The server 210 can be any type of a calculation platform, for example, a cloud server, a large-scale computer, a personal computer or other electronic devices. The server 210 can be set and managed by a system operator to provide a non-invasive home appliance load identification/monitoring service.

In FIG. 2, the smart meters 230A-230F are respectively installed in houses of different users (or companies and factories). The smart meters 230A-230F are respectively connected to one or a plurality of electrical appliances. The smart meters 230A-230F can measure electrical energy of at least one power line to obtain power usage data of the power line, wherein the power line can transmit electricity to one or a plurality of electrical appliances.

The smart meters 230A-230F can be respectively connected to the electronic devices 220A-220C through a local wireless communication network. The local wireless communication network may support IEEE 802.11 standard, IEEE 802.15.4 standard, Wi-Fi standard, Bluetooth standard, or ZigBee wireless communication protocol standard. The smart meters 230A-230F can respectively upload the power usage data to the electronic devices 220A-220C.

The electronic devices 220A-220C may comprise one or more types of connection devices. Exemplary electronic devices may include a hub, a gateway, a router, or any other suitable device. The electronic devices 220A-220C can be installed in houses of different users (or companies and factories) and communicate with the remote server 210 through a wireless communication network. The wireless communication network can be any type of a wireless communication mechanism, for example, a wireless local area network (WLAN), a low power wide area network (LPWAN), a Third Generation (3G) or a Fourth Generation (4G) mobile communication protocol, a Long Term Evolution (LTE) or other communication network. The electronic devices 220A-220C can respectively convert the power usage data received from the smart meters 230A-230F into Internet Protocol (IP) packets and upload the IP packets to the remote server 210 using the wireless communication network.

In one embodiment, the wireless communication protocol used between the smart meters 230A-230F and the electronic devices 220A-220C is different from the wireless communication protocol used between the server 210 and the electronic devices 220A-220C. In addition, the electronic devices 220A-220C may further include one or more processors configured to execute instructions stored by a computer-readable medium for performing various device operations, such as input/output, communication, data processing, and the like.

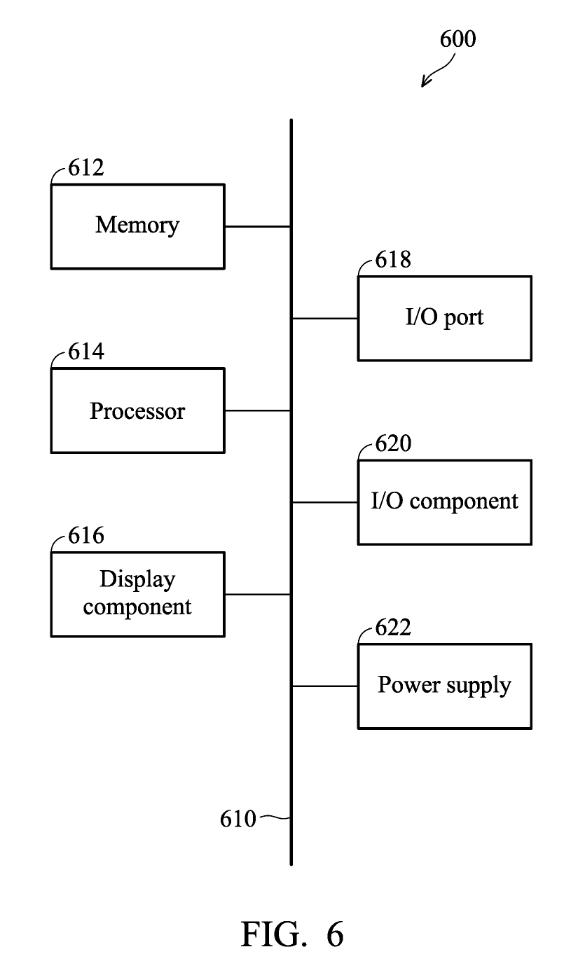

In addition, the electronic devices 220A-220C shown in FIG. 2 is an example of one suitable system 200 for enhancing the throughput between the smart meters and the server. Each of the components shown in FIG. 2 may be implemented via any type of electronic device, such as the electronic device 600 described with reference to FIG. 6, for example.

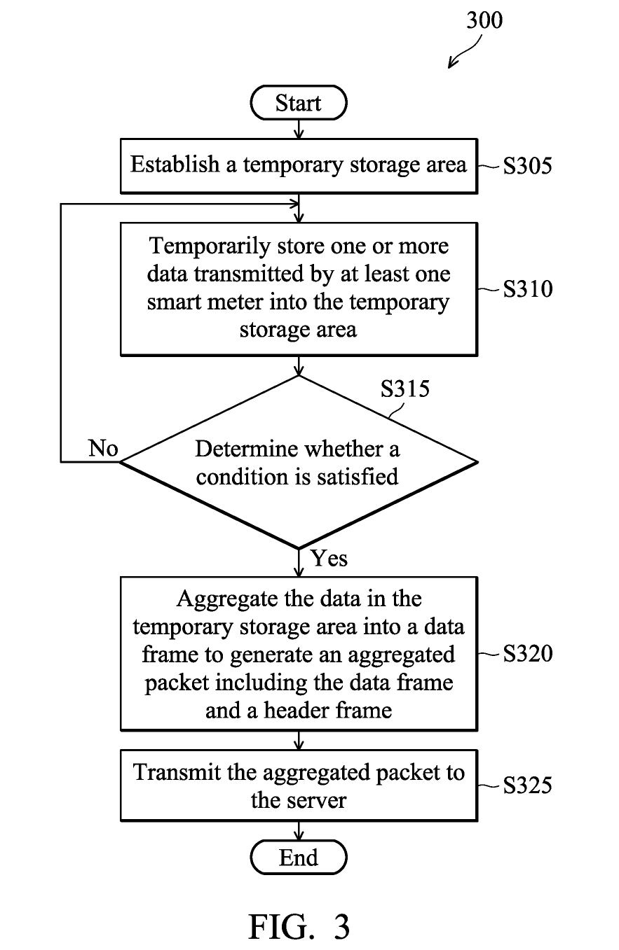

FIG. 3 is a flowchart illustrating a method 300 for enhancing the throughput between smart meters and a server according to an embodiment of the present disclosure. The method can be implemented in the processors of the electronic devices 220A-220C as shown in FIG. 2.

In step S305, the electronic device establishes a temporary storage area in a memory of the electronic device. In step S310, the electronic device temporarily stores one or more data transmitted by at least one smart meter into the temporary storage area. In an embodiment, before temporarily storing the data into the temporary storage area, the electronic device may assign sequence numbers to the data according to a receiving order in which the data were received, for example, adding a sequence number field into each data. When each of the data contains an identifier (ID) field indicating an ID of the data, the electronic device does not need to assign a sequence number to the data.

In step S315, the electronic device determines whether a condition is satisfied, wherein the conditions include at least one of the following: the size of the temporary storage area reaches a threshold (for example, 1500 bytes) or a predetermined time period has arrived (for example, one hour).

When the condition is satisfied (“Yes” in step S315), in step S320, the electronic device aggregates the data in the temporary storage area into a data frame to generate an aggregated packet including the data frame and a header frame, wherein the aggregated packet is an Internet Protocol (IP) packet. In step S325, the electronic device transmits the aggregated packet to the server. When the condition is not satisfied (“No” in step S315), the process returns to step S310, and the electronic device continues to temporarily store the data transmitted by the smart meter into the temporary storage area.

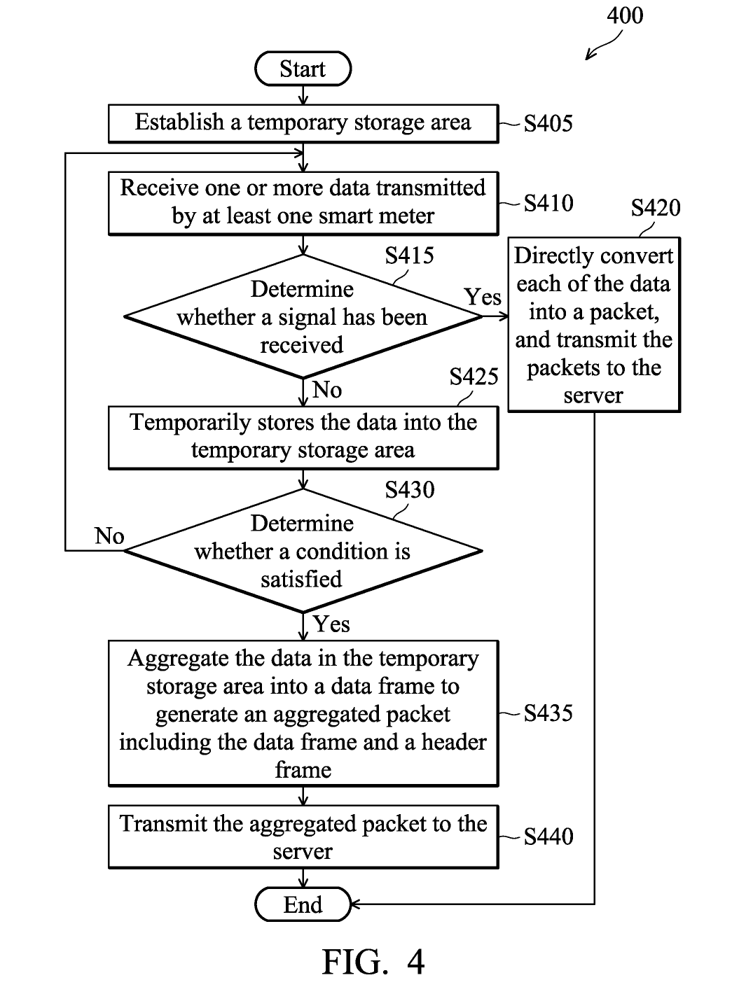

FIG. 4 is a flowchart illustrating a method 400 for enhancing the throughput between smart meters and a server according to an embodiment of the present disclosure. The method can be implemented in the processors of the electronic devices 220A-220C as shown in FIG. 2.

In step S405, the electronic device establishes a temporary storage area in a memory of the electronic device. In step S410, the electronic device receives one or more data transmitted by at least one smart meter. In step S415, the electronic device determines whether a signal has been received, wherein the signal is used to instruct the electronic device to transmit the data immediately. In an embodiment, the signal may be transmitted by the server to the electronic device or may be transmitted to the electronic device by the smart meter.

When the electronic device has received the signal (“Yes” in step S415), in step S420, the electronic device does not temporarily store the data into the temporary storage area, directly converts each of the data into a packet, and transmits the packets to the server, wherein each of the packets is an IP packet.

When the electronic device does not receive the signal (“No” in step S415), in step S425, the electronic device temporarily stores the data into the temporary storage area. In an embodiment, before temporarily storing the data into the temporary storage area, the electronic device may assign sequence numbers to the data according to a receiving order in which the data were received, for example, adding a sequence number field into each data. When each of the data contains an identifier (ID) field indicating an ID of the data, the electronic device does not need to assign a sequence number to the data.

In step S430, the electronic device determines whether a condition is satisfied, wherein the conditions include at least one of the following: the size of the temporary storage area reaches a threshold (for example, 1500 bytes) or a predetermined time period has arrived (for example, one hour).

When the condition is satisfied (“Yes” in step S430), in step S435, the electronic device aggregates the data in the temporary storage area into a data frame to generate an aggregated packet including the data frame and a header frame, wherein the aggregated packet is an Internet Protocol (IP) packet. In step S440, the electronic device transmits the aggregated packet to the server. When the condition is not satisfied (“No” in step S430), the process returns to step S410, and the electronic device continues to receive the data transmitted by the smart meter.

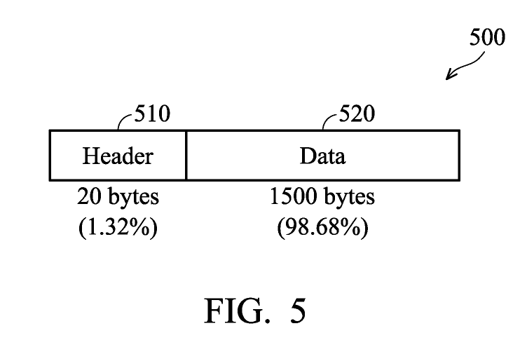

FIG. 5 is a schematic diagram showing an aggregated packet 500 according to an embodiment of the present disclosure. It is assumed that when the electronic device determines that the size of the temporary storage area reaches a threshold of 1500 bytes, the electronic device aggregates the data in the temporary storage area into a data frame 520 to generate an aggregated packet 500 including the data frame 520 and a header frame 510. As shown in FIG. 5, the header frame 510 is 20 bytes, and the data frame 520 is 1500 bytes. Obviously, the ratio of the data frame 520 to the aggregated packet 500 is 98.68%, and therefore the purpose of enhancing the throughput is achieved.

In addition, since the data is accumulated in the temporary storage area and sent to the server by the electronic device at one time, the number of times the electronic device establishes a connection with the server can be reduced, and the server can receive the load transmitted by more smart meters.

Having described embodiments of the present disclosure, an exemplary operating environment in which embodiments of the present disclosure may be implemented is described below. Referring to FIG. 6, an exemplary operating environment for implementing embodiments of the present disclosure is shown and generally known as an electronic device 600. The electronic device 600 is merely an example of a suitable computing environment and is not intended to limit the scope of use or functionality of the disclosure. Neither should the electronic device 600 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 6, the electronic device 600 may include a bus 610 that is directly or indirectly coupled to the following devices: one or more memories 612, one or more processors 614, one or more display components 616, one or more input/output (I/O) ports 618, one or more input/output components 620, and an illustrative power supply 622. The bus 610 may represent one or more kinds of busses (such as an address bus, data bus, or any combination thereof). Although the various blocks of FIG. 6 are shown with lines for the sake of clarity, and in reality, the boundaries of the various components are not specific. For example, the display component such as a display device may be considered an I/O component and the processor may include a memory.

The electronic device 600 typically includes a variety of computer-readable media. The computer-readable media can be any available media that can be accessed by electronic device 600 and includes both volatile and nonvolatile media, removable and non-removable media. By way of example, but not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the computing device 600. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 612 may include computer-storage media in the form of volatile and/or nonvolatile memory. The memory may be removable, non-removable, or a combination thereof. Exemplary hardware devices include solid-state memory, hard drives, optical-disc drives, etc. The electronic device 600 includes one or more processors that read data from various entities such as the memory 612 or the I/O components 620. The display component(s) 616 present data indications to a user or other device. Exemplary presentation components include a display device, speaker, printing component, vibrating component, etc.

The I/O ports 618 allow the electronic device 600 to be logically coupled to other devices including the I/O components 620, some of which may be embedded. Illustrative components include a microphone, joystick, game pad, satellite dish, scanner, printer, wireless device, etc. The I/O components 620 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the electronic device 600, or any combination thereof. The electronic device 600 may be equipped with depth cameras, such as stereoscopic camera systems, infrared camera systems, RGB camera systems, or any combination thereof, to realize gesture detection and recognition. Furthermore, the electronic device 600 may be equipped with accelerometers or gyroscopes that enable detection of motion. The output of the accelerometers or gyroscopes may be provided to the display of the computing device 600 to carry out immersive augmented reality or virtual reality.

Furthermore, the processor 614 in the electronic device 600 can execute the program code in the memory 612 to perform the above-described actions and steps or other descriptions herein.

As described above, since the method and device for incremental upgrade provided in the present disclosure further consider the idle resource of the memory, the utilization of the idle resource of the memory can be improved to optimize the time of incremental upgrade of the device.

In addition, in the above exemplary device, although the method has been described on the basis of the flow diagram using a series of steps or blocks, the present invention is not limited to this sequence of steps, and some of the steps may be performed in a different order than that of the remaining steps, or they may be performed simultaneously with the remaining steps. For example, the electronic device may first receive a signal transmitted by the server or the smart meter to instruct the electronic device to transmit the data immediately, and then receive one or more data transmitted by the smart meter. Furthermore, those skilled in the art will understand that the steps shown in the flow diagram are not exclusive and they may include other steps or one or more steps of the flow diagram may be deleted without affecting the scope of the present invention.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for enhancing the throughput between smart meters and a server, used in a device, comprising:
establishing a temporary storage area;
temporarily storing one or more data transmitted by at least one smart meter into the temporary storage area;
determining whether a condition is satisfied;
aggregating the data in the temporary storage area into a data frame to generate an aggregated packet including the data frame and a header frame when determining that the condition is satisfied; and
transmitting the aggregated packet to the server.

2. The method for enhancing the throughput between smart meters and a server as claimed in claim 1, wherein the conditions include at least one of the following:
the size of the temporary storage area reaches a threshold; or
a predetermined time period has arrived.

3. The method for enhancing the throughput between smart meters and a server as claimed in claim 1, wherein before temporarily storing the data transmitted by the smart meter, the method comprises:
determining whether a signal has been received, wherein the signal is used to instruct the device to transmit the data immediately;
converting each of the data into a packet when determining that the signal has been received; and
transmitting the packet to the server.

4. The method for enhancing the throughput between smart meters and a server as claimed in claim 1, before temporarily storing the data into the temporary storage area, the method comprises:
assigning sequence numbers to the data according to a receiving order in which the data were received.

5. The method for enhancing the throughput between smart meters and a server as claimed in claim 1, wherein the aggregated packet is an Internet Protocol (IP) packet.

6. The method for enhancing the throughput between smart meters and a server as claimed in claim 1, wherein the first wireless communication protocol used between the smart meter and the device is different from the second wireless communication protocol used between the server and the device.

7. The method for enhancing the throughput between smart meters and a server as claimed in claim 1, wherein the device is a hub.

8. A device for enhancing the throughput between smart meters and a server, comprising:
one or more processors; and
one or more computer storage media for storing one or more computer-readable instructions, wherein the processor is configured to drive the computer storage media to execute the following tasks:
establishing a temporary storage area;
temporarily storing one or more data transmitted by at least one smart meter into the temporary storage area;
determining whether a condition is satisfied;
aggregating the data in the temporary storage area into a data frame to generate an aggregated packet including the data frame and a header frame when determining that the condition is satisfied; and
transmitting the aggregated packet to the server.

9. The device for enhancing the throughput between smart meters and a server as claimed in claim 8, wherein the conditions include at least one of the following:
the size of the temporary storage area reaches a threshold; or
a predetermined time period has arrived.

10. The device for enhancing the throughput between smart meters and a server as claimed in claim 8, wherein before temporarily storing the data transmitted by the smart meter, the processor further executes:
determining whether a signal has been received, wherein the signal is used to instruct the device to transmit the data immediately;
converting each of the data into a packet when determining that the signal has been received; and
transmitting the packet to the server.

11. The device for enhancing the throughput between smart meters and a server as claimed in claim 8, wherein before temporarily storing the data into the temporary storage area, the processor further executes:
assigning sequence numbers to the data according to a receiving order in which the data were received.

12. The device for enhancing the throughput between smart meters and a server as claimed in claim 8, wherein the aggregated packet is an Internet Protocol (IP) packet.

13. The device for enhancing the throughput between smart meters and a server as claimed in claim 8, wherein the first wireless communication protocol used between the smart meter and the device is different from the second wireless communication protocol used between the server and the device.

14. The device for enhancing the throughput between smart meters and a server as claimed in claim 8, wherein the device is a hub.
